(19) United States
(12) Patent Application Publication
(10) Pub. No.: US 2024/0391459 A1
(43) Pub. Date: Nov. 28, 2024

(54) VEHICLE CONTROL DEVICE AND VEHICLE CONTROL METHOD

(71) Applicant: HONDA MOTOR CO., LTD., Minato-ku, Tokyo (JP)

(72) Inventors: Tatsuya Naito, Tokyo (JP); Mutsuki Hirooka, Tokyo (JP); Kazuhiko Kameda, Tokyo (JP); Yuichi Yoshii, Tokyo (JP); Takuro Hashimoto, Tokyo (JP)

(21) Appl. No.: 18/429,506

(22) Filed: Feb. 1, 2024

(30) Foreign Application Priority Data
Feb. 9, 2023 (JP) 2023-018419

(51) Int. Cl. B60W 30/16; B60W 30/18

(52) U.S. Cl. CPC B60W 30/16; B60W 30/18163; B60W 2520/10

(57) ABSTRACT

A vehicle control device according to one aspect of the present invention includes a storage device configured to store a program, and a processor that is connected to the storage device, in which the processor executes a program stored in the storage device, thereby detecting a road surface condition of a road surface on which a host vehicle is present, detecting a preceding vehicle that is present in front of the host vehicle and moves in the same direction as the host vehicle, deriving a spray distance of a sprayed object caused by the preceding vehicle when the preceding vehicle is detected and the road surface condition is a predetermined condition, and calculating a recommended inter-vehicle distance on the basis of the spray distance.

### CROSS-REFERENCE TO RELATED APPLICATION

Priority is claimed on Japanese Patent Application No. 2023-018419, filed Feb. 9, 2023, the content of which is incorporated herein by reference.

### BACKGROUND

### Field of the Invention

The present invention relates to a vehicle control device and a vehicle control method.

### Description of Related Art

Research and practical use of driving assistance devices that assist a driver of a vehicle have been in progress. For example, Patent Document 1 describes a device that measures a coefficient of friction between a host vehicle and a road surface, and controls a display regarding an inter-vehicle distance according to the measured value. In addition, Patent Document 2 describes a device in which a driver registers his or her driving preferences, and when the registered state is reached, vehicle control is performed to drive in a manner similar to a determination of the driver (Japanese Unexamined Patent Application, First Publication No. 2019-139441, Japanese Unexamined Patent Application, First Publication No. 2018-013897).

### SUMMARY

In the conventional technology described above, spray from a preceding vehicle accompanying travel of a host vehicle is not taken into account, and the vehicle may become dirty due to the spray from the preceding vehicle while the host vehicle is traveling. In addition, there have been cases in which it is not possible to assist the driver in preventing dirt from being attached to cameras and sensors used for driving assistance.

The present invention has been made in consideration of such circumstances, and an object thereof is to provide a vehicle control device and a vehicle control method that assist a driver in preventing dirt from being attached to cameras and sensors used for driving assistance.

A vehicle control device and a vehicle control method according to the present invention have adopted the following configuration.
(1): A vehicle control device according to one aspect of the present invention includes a storage device configured to store a program, and a processor that is connected to the storage device, in which the processor executes a program stored in the storage device, thereby detecting a road surface condition of a road surface on which a host vehicle is present, detecting a preceding vehicle that is present in front of the host vehicle and moves in the same direction as the host vehicle, deriving a spray distance of a sprayed object caused by the preceding vehicle when the preceding vehicle is detected and the road surface condition is a predetermined condition, and calculating a recommended inter-vehicle distance on the basis of the spray distance.
(2): In the aspect of (1) described above, the processor may detect a type of a sprayed object present on the road surface on which the host vehicle travels as one of the road surface conditions, and the spray distance derivation unit may derive a spray distance according to the type of the sprayed object.
(3): In the aspect of (1) described above, the processor may detect a type of the preceding vehicle and the spray distance derivation unit may derive a spray distance based on the type of the preceding vehicle.
(4): In the aspect of (1) described above, the processor may detect a speed of the preceding vehicle and the spray distance derivation unit may derive a spray distance according to the speed of the preceding vehicle.
(5): In the aspect of (1) described above, the processor may acquire a weather condition of the road surface on which the host vehicle is present, and calculate a correction value based on the weather condition, and the recommended inter-vehicle distance calculation unit may calculate the recommended inter-vehicle distance on the basis of the spray distance and the correction value.
(6): In the aspect of (1) described above, the processor may cause a display unit to display an image representing the preceding vehicle and the recommended inter-vehicle distance.
(7): In the aspect of (1) described above, the processor may cause a display unit to display an image in which a guide line is displayed at a position spaced the recommended inter-vehicle distance from a rear end of the preceding vehicle.
(8): A vehicle control device according to still another aspect of the present invention includes a storage device configured to store a program, and a processor that is connected to the storage device, in which the processor executes a program stored in the storage device, thereby detecting a road surface condition of a road surface on which a host vehicle is present, detecting a preceding vehicle that is present in front of the host vehicle and moves in the same direction as the host vehicle, deriving a spray distance of a sprayed object caused by the preceding vehicle when the preceding vehicle is detected and the road surface condition is a predetermined condition, calculating a recommended inter-vehicle distance on the basis of the spray distance, and controlling a drive device of the host vehicle so that an inter-vehicle distance with the preceding vehicle becomes the recommended inter-vehicle distance.
(9): In the aspect of (8) described above, the processor may ascertain a surrounding condition of the host vehicle, determine based on the surrounding condition whether a lane change to an adjacent lane of the host vehicle is possible, control steering of the host vehicle, receive a setting of a target inter-vehicle distance between the host vehicle and the preceding vehicle by an occupant of the host vehicle, and cause the host vehicle to change lanes when the target inter-vehicle distance is shorter than the recommended inter-vehicle distance and the lane change determination unit determines that a lane change is possible.
(10): In the aspect of (9) described above, the processor may cause the host vehicle to change lanes when the recommended inter-vehicle distance is greater than a predetermined distance and the lane change determination unit determines that a lane change is possible.
(11): A vehicle control method executed using a computer according to still another aspect of the present invention includes detecting a road surface condition of a road surface on which a host vehicle is present, detecting a preceding vehicle that is present in front of the host vehicle and moves in the same direction as the host vehicle, deriving a spray distance of a sprayed object caused by the preceding vehicle when the preceding vehicle is detected and the road surface condition is a predetermined condition, and calculating a recommended inter-vehicle distance on the basis of the spray distance.

According to aspects of (1) to (11), it is possible to assist the driver in preventing dirt from adhering to a camera or a sensor used for driving assistance.

### BRIEF DESCRIPTION OF THE DRAWINGS

FIG. 1 is a configuration diagram of a vehicle equipped with a vehicle control device according to a first embodiment.

FIG. 2 is a diagram which shows an example of a distance table according to the first embodiment for deriving a distance of spray generated from a preceding vehicle.

FIG. 3 is a flowchart which represents an example of an operation executed by the vehicle control device according to the first embodiment.

FIG. 4 is a flowchart which represents an example of an operation executed by a vehicle control device according to a second embodiment.

FIG. 5 is an example of a distance table of the vehicle control device according to the second embodiment.

FIG. 6 is a functional configuration diagram of a vehicle control device according to a third embodiment.

FIG. 7 is a flowchart which represents an example of an operation executed by the vehicle control device according to the third embodiment.

FIG. 8 is a functional configuration diagram of a vehicle control device according to a fourth embodiment.

FIG. 9 is an example of an image displayed on a display unit by the vehicle control device according to the fourth embodiment.

FIG. 10 is a diagram which shows an example of an image when the display unit of the vehicle control device according to the fourth embodiment is a head up display (HUD).

FIG. 11 is a flowchart which represents an example of an operation executed by the vehicle control device according to the fourth embodiment.

FIG. 12 is a functional configuration diagram of a vehicle control device according to a fifth embodiment.

FIG. 13 is a flowchart which shows an example of a flow of processing executed by the vehicle control device of the fifth embodiment.

FIG. 14 is a flowchart which represents an example of an operation executed by the vehicle control device according to the fifth embodiment.

FIG. 15 is an example of a lane change operation executed by the vehicle control device according to the fifth embodiment.

FIG. 16 is an example of the lane change operation executed by the vehicle control device according to the fifth embodiment.

FIG. 17 is an example of a case where a lane change determination unit of the vehicle control device according to the fifth embodiment determines that a lane change is not possible.

### DETAILED DESCRIPTION OF THE INVENTION

Hereinafter, embodiments of a vehicle control device and a vehicle control method of the present invention will be described with reference to the drawings.

### First embodiment

### Overall Configuration

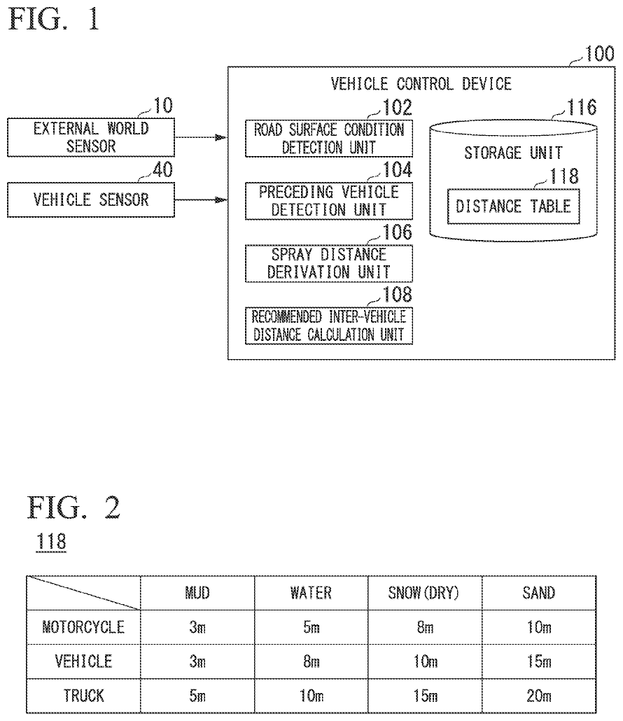

FIG. 1 is a configuration diagram of a vehicle control device 100 using a vehicle control device according to a first embodiment. A vehicle is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or discharge power of secondary batteries or fuel cells.

The vehicle includes, for example, an external world sensor 10 and a vehicle sensor 40. These devices and apparatuses are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added.

The external world sensor 10 is, for example, a camera. For example, the camera is a digital camera that uses a solid-state imaging device such as a charge coupled device (CCD) or a complementary metal oxide semiconductor (CMOS). The camera is attached to any location of a vehicle equipped with the vehicle control device 100 (hereinafter referred to as a host vehicle M). When a forward image is captured, the camera is attached to a top of the front windshield or a rear surface of the rearview mirror, the like. For example, the camera periodically and repeatedly captures an image of the surroundings of the host vehicle M. The camera may be a stereo camera. Moreover, in addition to the camera, the vehicle control device 100 may include a radar device, light detection and ranging (LIDAR), sonar, and the like.

The vehicle sensor 40 includes a vehicle speed sensor that detects a speed of the host vehicle M, an acceleration sensor that detects acceleration, a yaw rate sensor that detects an angular speed around a vertical axis, an azimuth sensor that detects a direction of the host vehicle M, and the like.

The vehicle control device 100 of the first embodiment includes a road surface condition detection unit 102, a preceding vehicle detection unit 104, a spray distance derivation unit 106, a recommended inter-vehicle distance calculation unit 108, and a storage unit 116. Components other than the storage unit 116 are realized by, for example, a hardware processor such as a central processing unit (CPU) executing a program (software). Some or all of these components may be realized by hardware (a circuit unit; including circuitry) such as large scale integration (LSI), an application specific integrated circuit (ASIC), a field-programmable gate array (FPGA), or a graphics processing unit (GPU), or may be realized by software and hardware in cooperation. A program may be stored in advance in a storage device (a storage device having a non-transitory storage medium) such as a hard disk drive (HDD) or a flash memory, or may be stored in a detachable storage medium (non-transitory storage medium) such as a DVD or a CD-ROM and installed by the storage medium being attached to a drive device.

The road surface condition detection unit 102 detects a condition of a road surface that the host vehicle M is in contact with on the basis of information input via an external world sensor 10 such as a camera when the host vehicle M is traveling in a traveling lane. Specifically, the road surface condition detection unit 102 detects a sprayed object on the basis of the input information. Sprayed objects are objects that are scattered behind the preceding vehicle when wheels (especially drive wheels) of the preceding vehicle roll up and may fall on the host vehicle, and are classified into water, snow, sand, and mud. The road surface condition detection unit 102 may recognize a type of a sprayed object classified in this manner.

The preceding vehicle detection unit 104 detects a preceding vehicle that is present in front of the host vehicle M and moves in the same direction as the host vehicle M. The preceding vehicle is a vehicle that is traveling in front of the host vehicle M in the traveling lane or in a lane adjacent to the traveling lane. The preceding vehicle detection unit 104 detects a preceding vehicle on the basis of information input via the external world sensor 10 such as a camera. Furthermore, the preceding vehicle detection unit 104 may detect a type of a preceding vehicle by inputting, for example, an image captured by a camera to a learned model learned by machine learning. The type of the preceding vehicle is classified into, for example, two-wheeled vehicles, four-wheeled vehicles, trucks, and the like. Furthermore, among four-wheeled vehicles, it is only necessary to identify a type of a vehicle, such as a light vehicle, a regular vehicle, or a sedan. Since a size of a vehicle tire and a depth of a groove vary depending on the type of the vehicle, and aerodynamic effects vary depending on a height of the vehicle and a shape of the vehicle, more detailed information may be detected.

The spray distance derivation unit 106 derives a spray distance of a sprayed object from a preceding vehicle when the preceding vehicle is detected and a road surface condition is a predetermined condition. More specifically, the spray distance derivation unit 106 may derive the spray distance according to a sprayed object detected by the road surface condition detection unit 102, may derive the spray distance according to the type of the preceding vehicle of the host vehicle M, or may derive the spray distance according to both.

The storage unit 116 stores information such as a distance table 118. The storage unit 116 may be the same as or may be different from the storage device that stores the program described above.

FIG. 2 is a diagram which shows an example of a distance table according to the first embodiment for deriving the spray distance of spray generated from a preceding vehicle. The distance table 118 is a table in which information for deriving the spray distance by the spray distance derivation unit 106 is stored. The distance table 118 is, for example, information that describes a spray distance serving as a reference for a combination of the type of a preceding vehicle and the type of a sprayed object. For example, in the example of FIG. 2, when the type of the preceding vehicle is a truck and the type of the sprayed object is water, the spray distance is 10 [m].

### Flowchart

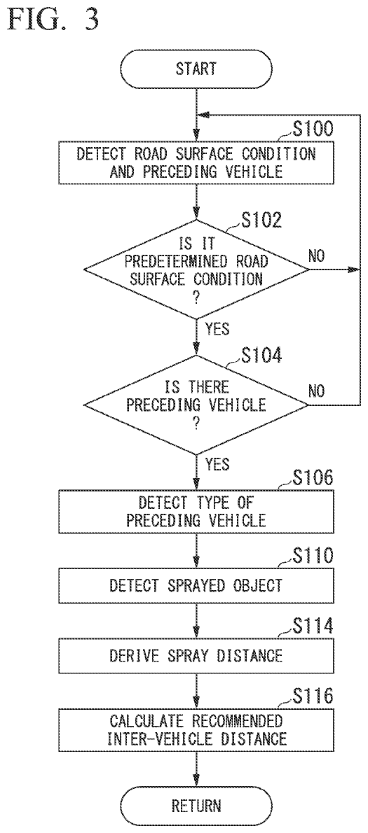

FIG. 3 is a flowchart which shows an example of a flow of processing executed by the vehicle control device 100 of the first embodiment. First, the road surface condition detection unit 102 detects a road surface condition, and the preceding vehicle detection unit 104 detects a preceding vehicle (step S100). Next, the road surface condition detection unit 102 determines whether the road surface condition is a predetermined road surface condition (step S102). When it is determined that the road surface condition is the predetermined road surface condition, the preceding vehicle detection unit determines whether the preceding vehicle is traveling in front of the host vehicle M (step S104). When it is determined that the preceding vehicle is traveling, the preceding vehicle detection unit 104 detects the type of the preceding vehicle (step S106). When a negative determination result is obtained in step S102 or S104, the processing returns to step S100.

Next, the road surface condition detection unit 102 detects a sprayed object generated from the preceding vehicle (step S110). The spray distance derivation unit 106 derives a spray distance on the basis of a combination of a type of the detected sprayed object and a type of the preceding vehicle (step S114).

Next, the recommended inter-vehicle distance calculation unit 108 calculates a recommended inter-vehicle distance on the basis of the derived spray distance (step S116). After the recommended inter-vehicle distance is calculated, processing returns to step S100 in this flowchart, and processing of this flowchart is repeated.

### Summary

According to the first embodiment described above, when a preceding vehicle is detected and a road surface condition is a predetermined condition, a spray distance of a sprayed object caused by the preceding vehicle is derived, and a recommended inter-vehicle distance is calculated on the basis of the spray distance. Therefore, a distance at which the vehicle is less likely to be affected by the sprayed object can be calculated as the recommended inter-vehicle distance. As a result, it is possible to assist the driver in preventing dirt from being attached to cameras and sensors used for driving assistance.

Furthermore, according to the first embodiment, it is possible to calculate the recommended inter-vehicle distance more accurately by detecting the type of a sprayed object present on a road surface on which the host vehicle is traveling as one of the road surface conditions, and deriving the spray distance according to the type of the sprayed object.

Furthermore, according to the first embodiment, it is possible to calculate the recommended inter-vehicle distance more accurately by detecting the type of the preceding vehicle and deriving the spray distance based on the type of the preceding vehicle.

### Second Embodiment

In the following description, a second embodiment will be described. Since the second embodiment basically has the same components as the first embodiment, illustration of the configuration diagram will be omitted. The second embodiment differss in a method of calculating a spray distance using the distance table 118. Hereinafter, a vehicle control device in the second embodiment will be referred to as a vehicle control device 100A, and a distance table will be referred to as a distance table 118A. The distance table 118A is information that describes a spray distance serving as a reference for a combination of the type of a preceding vehicle, the type of a sprayed object, and a speed of a preceding vehicle.

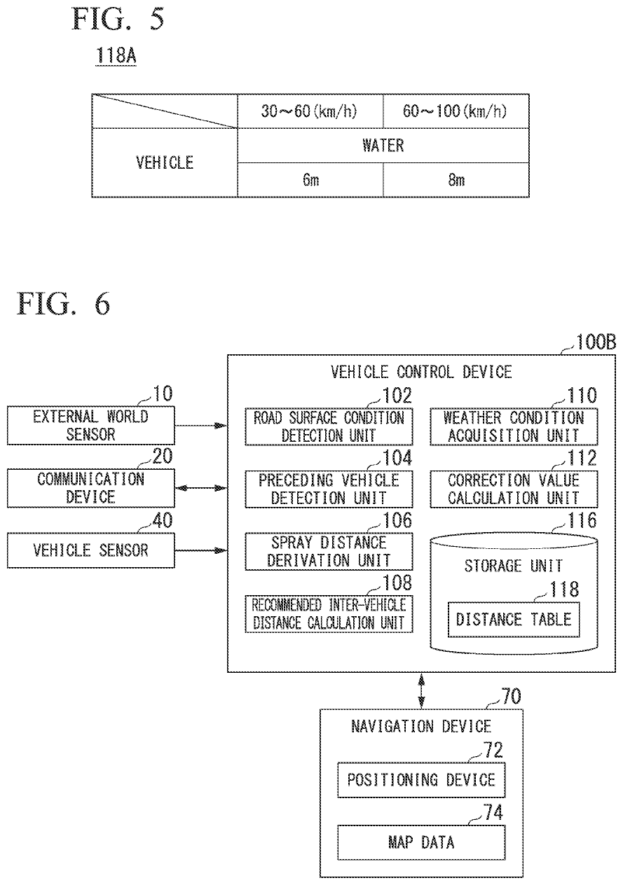

FIG. 5 is an example of the distance table 118A of the vehicle control device 100A according to the second embodiment. The distance table 118A is information that describes, for example, a spray distance serving as a reference for a combination of the type of a preceding vehicle and the type of a sprayed object for each speed zone. In the example shown in FIG. 5, when the type of a preceding vehicle is a vehicle, the type of a sprayed object is water, and the speed of a preceding vehicle is 30 to 60 [km/h], the spray distance is 30 m. Moreover, when the type of a preceding vehicle is a vehicle, the type of a sprayed object is water, and the speed of a preceding vehicle is 60 to 100 [km/h], the spray distance is 50 m. The spray distance derivation unit 106 of the second embodiment calculates the spray distance to be longer as the speed of a preceding vehicle increases. By calculating the speed of a preceding vehicle in this manner, it is possible to derive the spray distance more accurately. This is because the spray distance usually increases as the speed of a preceding vehicle increases.

### Flowchart

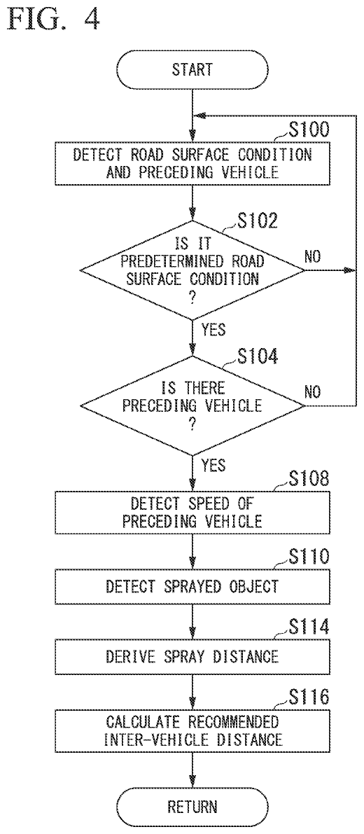

FIG. 4 is a flowchart which shows an example of a flow of processing executed by the vehicle control device 100A of the second embodiment. In FIG. 4, steps $100 to S104 are the same as in the flowchart of FIG. 3 described in the first embodiment, so that description thereof will be omitted.

After the processing in steps S100 to S104, the spray distance derivation unit 106 detects a sprayed object to be generated from the preceding vehicle (step S110). The spray distance derivation unit 106 derives the spray distance on the basis of the combination of the type of the detected sprayed object and the type of the preceding vehicle (step S114).

Next, the recommended inter-vehicle distance calculation unit 108 calculates the recommended inter-vehicle distance on the basis of the derived spray distance (step S116). After the recommended inter-vehicle distance is calculated, the processing returns to step S100, and processing of this flowchart is repeated.

### Summary

According to the second embodiment described above, it is possible to calculate the recommended inter-vehicle distance more accurately by detecting the speed of the preceding vehicle and deriving the spray distance based on the speed of the preceding vehicle.

### Third Embodiment

### Overall Configuration

A third embodiment will be described below. FIG. 6 is a configuration diagram of a vehicle equipped with a vehicle control device 100B according to the third embodiment. The third embodiment further includes a weather condition acquisition unit compared to the first embodiment, and derives the spray distance on the basis of weather information, a sprayed object, and a type of a vehicle.

FIG. 6 is a configuration diagram of the vehicle equipped with the vehicle control device 100B according to the third embodiment. The vehicle control device 100B in the third embodiment includes a road surface condition detection unit 102, a preceding vehicle detection unit 104, a spray distance derivation unit 106, a recommended inter-vehicle distance calculation unit 108, a weather condition acquisition unit 110, a correction value calculation unit 112, and a storage unit 116.

The communication device 20 communicates with various server devices using, for example, a cellular network, a Wi-Fi network, Bluetooth (registered trademark), dedicated short range communication (DSRC), or the like.

A navigation device 70 includes, for example, a positioning device 72. The positioning device 72 is a device that measures a position of a mobile object 1. The positioning device 72 is, for example, a global navigation satellite system (GNSS) receiver, and specifies a position of the host vehicle M on the basis of a signal received from a GNSS satellite, and outputs the specified position as position information. Note that the position information of the host vehicle M may be estimated based on a position of a Wi-Fi base station to which the communication device 20 is connected.

The map data 74 is, for example, held by the navigation device 70, and is information in which coordinates output by the positioning device 72 can be converted into information such as an address.

The weather condition acquisition unit 110 acquires weather conditions around the host vehicle M. The weather condition acquisition unit 110 acquires weather conditions around the host vehicle M from a weather information providing server device (not shown) via the communication device 20. The weather conditions to be acquired include, for example, weather, precipitation, a wind speed, a wind direction, a snowfall, and a temperature.

The correction value calculation unit 112 calculates a correction value on the basis of the weather conditions acquired by the weather condition acquisition unit 110. For example, if the acquired weather information indicates that there is a lot of precipitation, x [m] is added to the spray distance. Note that the correction may be performed by setting a coefficient by which the spray distance is multiplied (or divided), instead of being performed by addition and subtraction. Moreover, the correction value calculation unit 112 may perform similar processing regarding an amount of snowfall and an amount of hail.

The spray distance derivation unit 106 calculates information that describes a spray distance serving as a reference for the combination of the type of a preceding vehicle and the type of a sprayed object based on the distance table 118.

The recommended inter-vehicle distance calculation unit 108 adds or subtracts the correction value calculated by the correction value calculation unit 112 to or from the spray distance derived by the spray distance derivation unit 106.

### Flowchart

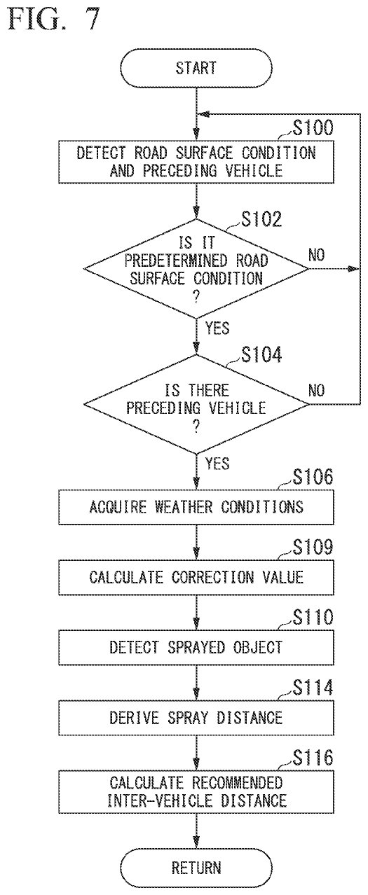

FIG. 7 is a flowchart which shows an example of the flow of processing executed by the vehicle control device 100B of the third embodiment. In FIG. 7, steps S100 to S104 are the same processing as in the first embodiment, so that description thereof will be omitted.

After the processing in steps S100 to S104 is completed, the weather condition acquisition unit 110 acquires the weather conditions around the host vehicle M via the communication device 20 (step S106). The correction value calculation unit 112 calculates a correction value based on the acquired weather conditions (step S109).

Next, the spray distance derivation unit 106 detects a sprayed object to be generated from a preceding vehicle (step S110). The spray distance derivation unit 106 derives a spray distance on the basis of a combination of the type of the detected sprayed object and the type of the preceding vehicle (step S114). The recommended inter-vehicle distance calculation unit 108 calculates a recommended inter-vehicle distance on the basis of the derived spray distance and the correction value (step S116). After the recommended inter-vehicle distance is calculated, the processing returns to step S100, and processing of this flowchart is repeated.

### Summary

According to the third embodiment described above, the weather conditions around the host vehicle M are acquired, and the correction value is calculated on the basis of the acquired weather conditions. By considering not only a road surface condition but also a surrounding weather condition, it is possible to calculate a recommended inter-vehicle distance more accurately, and a more accurate recommended inter-vehicle distance can be calculated. As a result, it is possible to assist the driver in preventing dirt from being attached to cameras and sensors used for driving assistance.

### Overall Configuration

### Fourth Embodiment

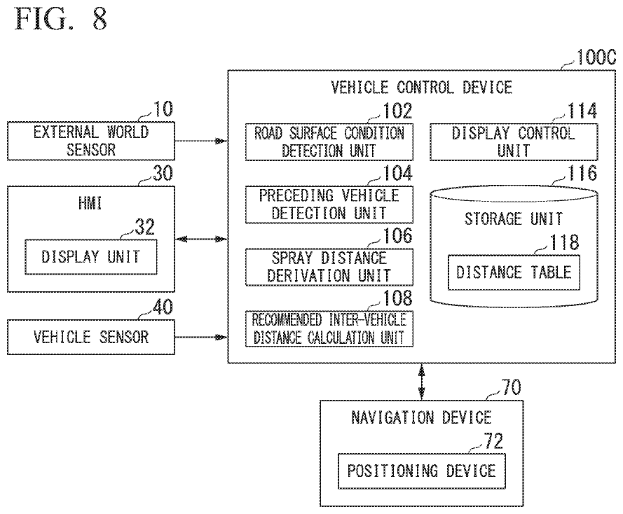

In the following description, a fourth embodiment will be described. The fourth embodiment has a configuration in which a display unit and a display control unit are further included compared to the first embodiment. FIG. 8 is a functional configuration diagram of a vehicle control device 100C according to the fourth embodiment.

FIG. 8 is a configuration diagram of a vehicle equipped with a vehicle control device 100C according to the fourth embodiment. A vehicle is equipped with an HMI 30. The HMI 30 presents various types of information to an occupant of the host vehicle M, and also receives an input operation from the occupant. The HMI 30 includes a display unit 32, a speaker, a buzzer, a touch panel, switches, keys, and the like.

Components of the vehicle control device 100C in the fourth embodiment include the road surface condition detection unit 102, the preceding vehicle detection unit 104, the spray distance derivation unit 106, the recommended inter-vehicle distance calculation unit 108, a display control unit 114, and the storage unit 116.

The display control unit 114 causes the display unit 32 to display an image representing a preceding vehicle and a recommended inter-vehicle distance. The display control unit 114 causes the display unit to display a guide line on an image at a position separated from a rear end of the preceding vehicle by the calculated recommended inter-vehicle distance. The guide line on the image displayed on the display unit moves as the vehicle moves.

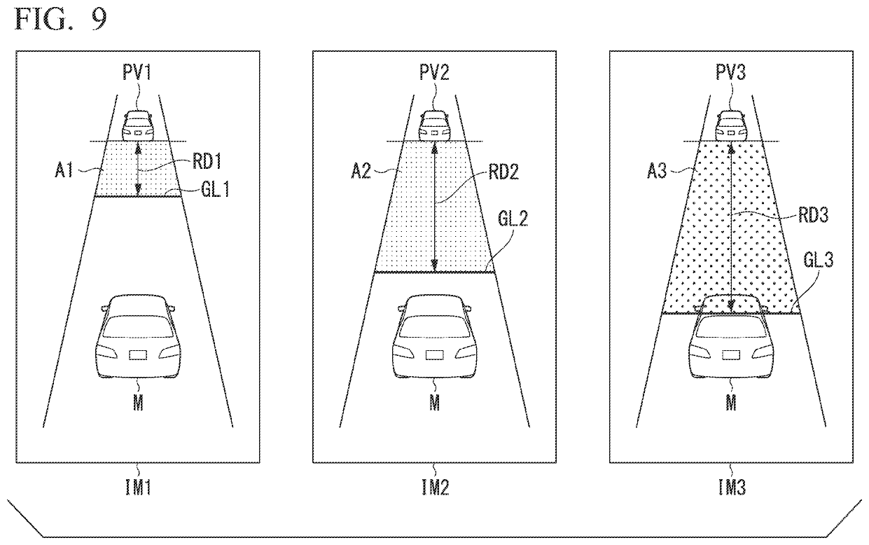

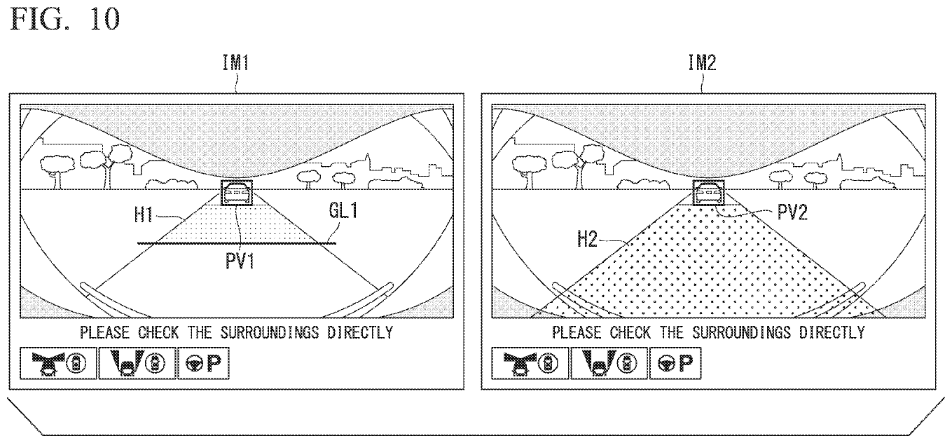

FIG. 9 is a diagram which shows an example of an image displayed on the display unit 32 by the vehicle control device 100C according to a fourth embodiment. The display unit 32 in this case is, for example, a display unit commonly used with a navigation device or a display unit inside a meter. The display control unit 114 causes the display unit 32 to display a guide line at a position separated from the rear end of the preceding vehicle by the calculated recommended inter-vehicle distance. The guide line on the image displayed on the display unit moves as the preceding vehicle moves. In FIG. 9, PV is a preceding vehicle, RD is a recommended inter-vehicle distance (a distance in real space projected onto an image plane), and GL is a guideline. IM1 is an image when the preceding vehicle is a motorcycle. In this case, since the motorcycle is derived to have a small spray distance (FIG. 2), a recommended inter-vehicle distance R1 is calculated short, and a guide line GL1 is displayed at a position close to the preceding vehicle. IM2 is an image when the preceding vehicle is a regular vehicle. Since a recommended inter-vehicle distance R2 is maintained sufficiently, a guide line GL2 is displayed at a position away from the preceding vehicle. IM3 is an image when the preceding vehicle is a truck. Since a recommended inter-vehicle distance R3 is long, a guide line GL3 is displayed at a position that extends over the host vehicle M. FIG. 10 is a diagram which shows an example of an image when the display unit 32 of the vehicle control device 100C according to the fourth embodiment is a head up display (HUD). In FIG. 10, only an example in which the preceding vehicle PV is a regular vehicle is shown. In the example of FIG. 10, a guideline GL is displayed so as to be superimposed on a point where an actual distance from the preceding vehicle PV on a road surface in real space is the recommended inter-vehicle distance R2 and to be visible to the driver. In addition, as an example, an area from the rear end of the preceding vehicle PV to the guide line GL may be colored. Furthermore, a displayed color may be changed depending on when the guide line GL is in front of the host vehicle M as in IM1 and IM2, and when the guide line GL extends over the host vehicle M as in IM3. For example, in the example of FIG. 10, areas A1 and A2 are displayed in a first color, and A3 is displayed in a second color.

### Flowchart

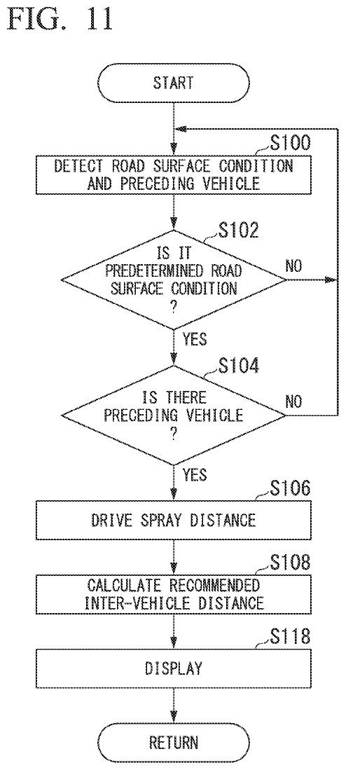

FIG. 11 is a flowchart which shows an example of a flow of processing executed by the vehicle control device 100C of the fourth embodiment. In FIG. 11, steps S100 to S108 are the same processing as in the flowchart of FIG. 3 described in the first embodiment, so that description thereof will be omitted.

After the processing in steps S100 to S108, the display control unit 114 displays the recommended inter-vehicle distance on the display unit 32 (step S118). After the recommended inter-vehicle distance is displayed, the processing returns to step S100, and processing of this flowchart is repeated.

### Summary

According to the fourth embodiment described above, it is possible to display the recommended inter-vehicle distance on the display unit so that the driver of the host vehicle M can visually understand how much inter-vehicle distance should be maintained. For this reason, driving can be performed without being affected by spray, and as a result, it is possible to assist the driver in preventing dirt from being attached to cameras and sensors used for driving assistance.

Furthermore, by displaying a guide line on the image displayed on the display unit, it is possible to cause the driver of the host vehicle M to ascertain an area where spray is present. By ascertaining the area where spray is present, the driver of the host vehicle M can recognize a more accurate recommended inter-vehicle distance.

### Fifth Embodiment

### Overall Configuration

In the following description, a fifth embodiment will be described. The fifth embodiment further includes a drive control unit, a condition ascertaining unit, a lane change determination unit, a steering control unit, and an inter-vehicle distance setting unit, compared to the first embodiment, and performs vehicle control according to a calculated spray distance.

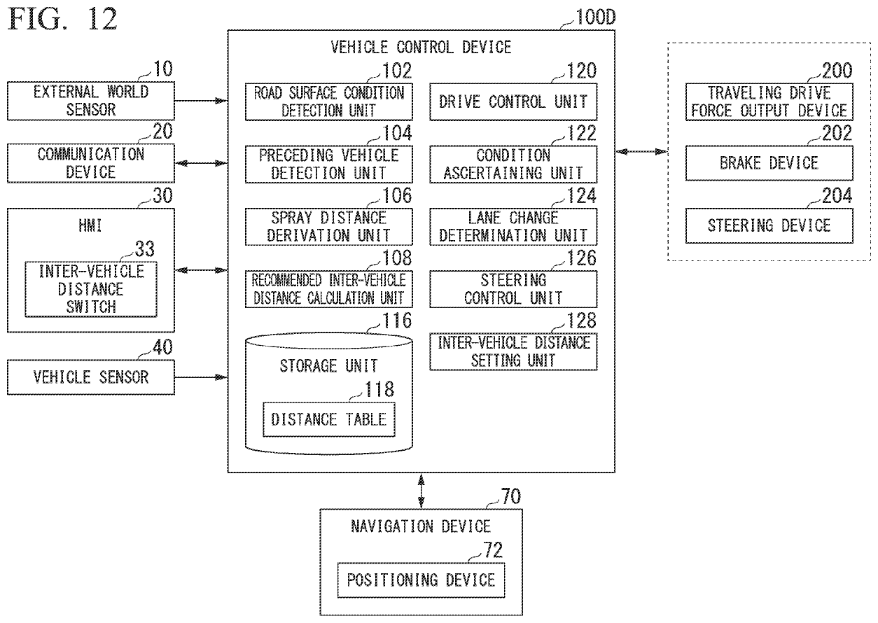

FIG. 12 is a functional configuration diagram of a vehicle control device 100D according to the fifth embodiment. The vehicle control device 100D in the fifth embodiment includes the road surface condition detection unit 102, the preceding vehicle detection unit 104, the spray distance derivation unit 106, the recommended inter-vehicle distance calculation unit 108, a drive control unit 120, and a condition ascertaining unit 122, a lane change determination unit 124, a steering control unit 126, and an inter-vehicle distance setting unit 128.

A traveling drive force output device 200 outputs a traveling drive force (torque) for traveling a vehicle to drive wheels. The traveling drive force output device 200 includes, for example, a combination of an internal combustion engine, an electric motor, a transmission, and the like, and an electronic control unit (ECU) that controls these. The ECU controls the constituents described above according to information input from the vehicle control device 100D or information input from a driving operator (not shown).

The brake device 202 includes, for example, a brake caliper, a cylinder that transmits hydraulic pressure to the brake caliper, an electric motor that generates hydraulic pressure to the cylinder, and an ECU. The ECU controls the electric motor according to information input from the vehicle control device 100D or information input from the driving operator, so that a brake torque corresponding to a braking operation is output to each wheel. The brake device 202 may include, as a backup mechanism, a mechanism that transmits hydraulic pressure generated by operating a brake pedal included in a driving operator to a cylinder via a master cylinder. Note that the brake device 202 is not limited to the constituent described above, and may be an electronically controlled hydraulic brake device that controls an actuator according to the information input from the vehicle control device 100D and transmits hydraulic pressure of the master cylinder to the cylinder.

A steering device 204 includes, for example, a steering ECU and an electric motor. For example, the electric motor applies force to a rack and pinion mechanism to change a direction of a steering wheel. The steering ECU drives the electric motor to change the direction of the steering wheel according to the information input from the vehicle control device 100D or the information input from the driving operator.

The drive control unit 120 controls drive devices (some or all of the traveling drive force output device 200, the brake device 202, and the steering device 204) when the host vehicle M intends to change lanes to an adjacent lane. In addition, when a target inter-vehicle distance is set, the drive control unit 120 controls acceleration or deceleration of the host vehicle M so that the inter-vehicle distance with the preceding vehicle PV is maintained at the target inter-vehicle distance. Moreover, the drive control unit 120 may automatically set the recommended inter-vehicle distance to the target inter-vehicle distance, and control the acceleration or deceleration of the host vehicle M so that the inter-vehicle distance with the preceding vehicle PV is maintained at the target inter-vehicle distance. Since contents of automatic lane change and inter-vehicle distance control themselves are well known, a detailed description thereof will be omitted.

The condition ascertaining unit 122 can ascertain the surrounding condition of the host vehicle M via, for example, the external world sensor 10 or the vehicle sensor 40. Map data in the present embodiment includes information such as the number of lanes for each road.

The lane change determination unit 124 determines, on the basis of the surrounding condition recognized by the condition ascertaining unit 122, whether to cause the host vehicle M to change lanes through driving control at the present moment or in the future. For example, the lane change determination unit 124 determines whether to cause the vehicle M to change lanes on the basis of a traveling lane of the vehicle M and the number of lanes on a road on which the vehicle M can travel in the same direction, including the traveling lane. The number of lanes is recognized by, for example, matching an image captured by a camera included in the external world sensor 10 with the map data 74. It may also be recognized from map information (for example, the positioning device 72). When the inter-vehicle distance set in the inter-vehicle distance setting unit 128, which will be described below, is shorter or longer than a recommended inter-vehicle distance, and when it is determined that a lane change to an adjacent lane is possible, the steering control unit 126, which will be described below, can be informed that a lane change is possible.

The steering control unit 126 can control steering of the host vehicle M. When it is determined that a lane change is possible, the steering control unit generates a target trajectory for performing the lane change. A target trajectory for the host vehicle M to naturally move to a center of an adjacent lane S2 along a spline curve is generated. Then, the steering device 204 is controlled to perform a lane change along the target trajectory.

The inter-vehicle distance setting unit 128 can ascertain a distance between the host vehicle M and the preceding vehicle via, for example, the external world sensor 10 or the vehicle sensor 40, and can transmit it to the lane change determination unit 124.

### Flowchart

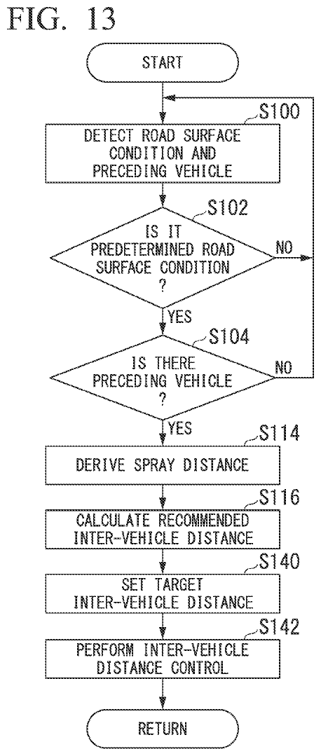

FIG. 13 is a flowchart which shows an example of a flow of processing executed by the vehicle control device 100D of the fifth embodiment. In FIG. 13, steps S100 to S116 are the same processing as in the flowchart of FIG. 3 described in the first embodiment, so that description thereof will be omitted.

The inter-vehicle distance setting unit 128 sets a target inter-vehicle distance (step S140).

The drive control unit 120 performs vehicle distance control to maintain the set target inter-vehicle distance (step S142).

According to the processing in the flowchart, the drive control unit 120 performs control so that the inter-vehicle distance with the preceding vehicle PV is maintained at the target inter-vehicle distance, thereby shortening a driving time at the inter-vehicle distance that is affected by spray.

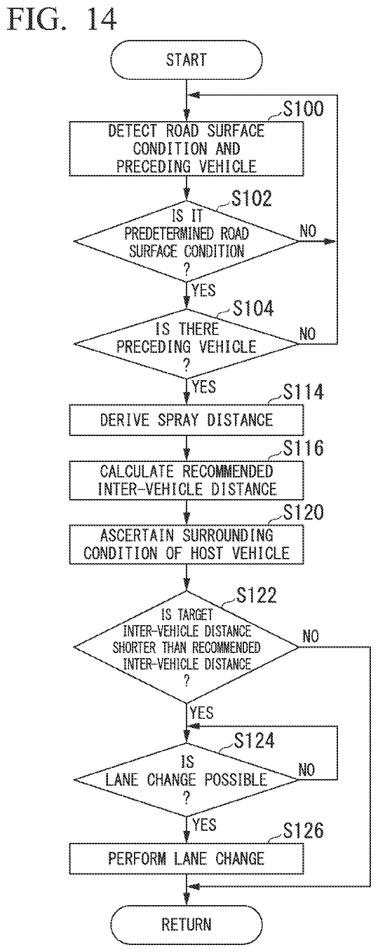

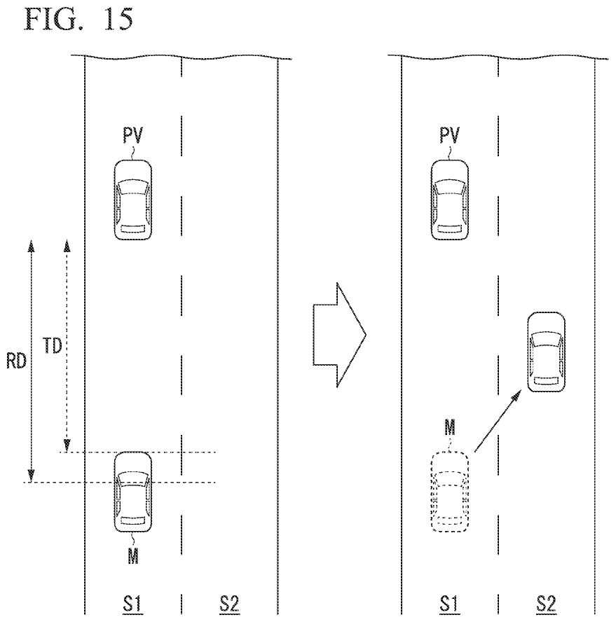

FIG. 14 is a flowchart which shows another example of the flow of processing executed by the vehicle control device 100D of the fifth embodiment. In FIG. 14, steps S100 to S116 are the same processing as in the flowchart of FIG. 3 described in the first embodiment, so that description thereof will be omitted.

After the processing in steps S100 to S116 is completed, the condition grasping unit 122 ascertains a surrounding condition of the host vehicle M (step S120).

The lane change determination unit 124 uses the distance between the host vehicle M and the preceding vehicle, which is transmitted from the inter-vehicle distance setting unit 128, as a target inter-vehicle distance, and compares whether it is shorter than the recommended inter-vehicle distance (step S122).

When the lane change determination unit 124 has determined in step S122 that the target inter-vehicle distance is shorter than the recommended inter-vehicle distance, it determines whether a lane change to an adjacent lane is possible (step S124). In addition, when the target inter-vehicle distance is greater than the recommended inter-vehicle distance, no lane change is performed.

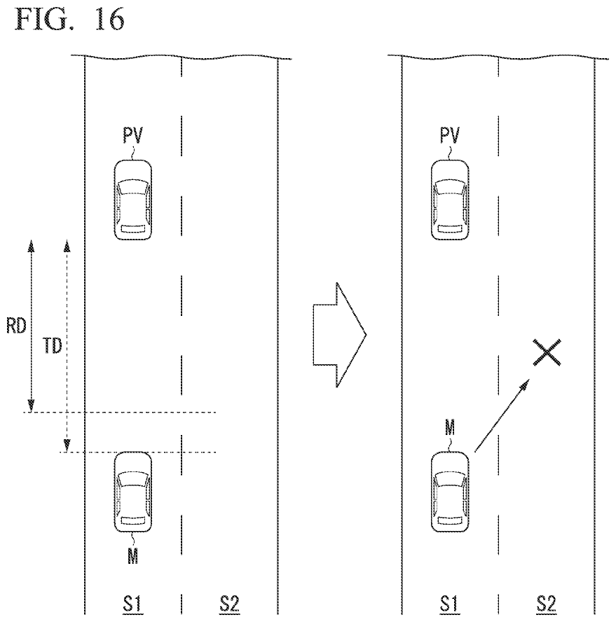

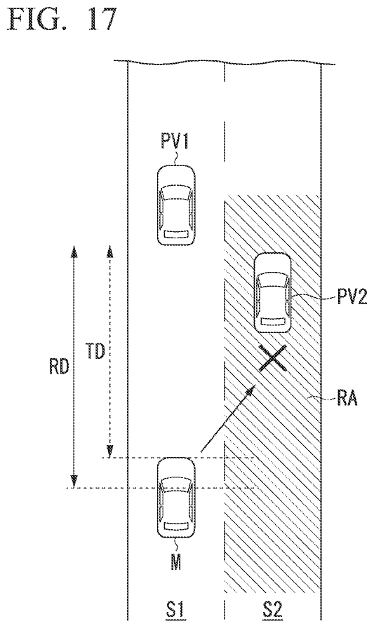

When the lane change determination unit 124 determines that a lane change to an adjacent lane is possible, the steering control unit 126 causes the steering device 204 to perform a lane change (step S126). FIG. 15 is an example of a lane change when a target inter-vehicle distance is shorter than a recommended inter-vehicle distance. In the following drawings, TD is a target inter-vehicle distance, S1 is a lane in which the host vehicle M is present (a host lane), and S2 is an adjacent lane to which the lane change is to be made. In this case, since a recommended inter-vehicle distance RD is shorter than the target inter-vehicle distance TD, the lane change determination unit 124 determines to perform a lane change because an attempt to shorten an inter-vehicle distance will be affected by spray. FIG. 16 is an example of a lane change when the target inter-vehicle distance TD is longer than the recommended inter-vehicle distance RD. In this case, the inter-vehicle distance is maintained longer than the recommended inter-vehicle distance RD, so that no lane change is performed. FIG. 17 is an example of a case in which the lane change determination unit 124 determines that a lane change is not possible. In FIG. 17, RA is a prohibited area in which it is determined that a lane change is not possible when other vehicles are present within a corresponding area. In an example of FIG. 17, since the preceding vehicle PV2 is within the prohibited area RA, it is determined that a lane change is not possible.

When the lane change determination unit 124 determines that a lane change is not possible, the processing returns to step S100 and processing of this flowchart is repeated.

### Summary

According to the fifth embodiment described above, an influence of spray from the preceding vehicle can be suppressed by automatically controlling the inter-vehicle distance on the basis of the calculated recommended inter-vehicle distance. As a result, it is possible to assist driving in preventing dirt from being attached to cameras and sensors used for driving assistance.

Furthermore, when there is a difference between the recommended inter-vehicle distance and the target inter-vehicle distance, a lane change is performed, and thereby it is possible to shorten the driving time at the inter-vehicle distance that is affected by spray.

Furthermore, when the inter-vehicle distance is larger than the recommended inter-vehicle distance, since there is a possibility that the inter-vehicle distance may be shortened, a lane change is performed, and thereby it is possible to shorten the driving time at the inter-vehicle distance that is affected by spray.

Since the embodiments described above are not mutually exclusive, they can be configured in combination as appropriate.

Although a mode for carrying out the present invention has been described above using the embodiment, the present invention is not limited to the embodiment, and various modifications and substitutions can be made within a range not departing from the gist of the present invention.

What is claimed is:

1. A vehicle control device comprising:
a storage device configured to store a program; and
a processor that is connected to the storage device,
wherein the processor executes a program stored in the storage device, thereby
detecting a road surface condition of a road surface on which a host vehicle is present,
detecting a preceding vehicle that is present in front of the host vehicle and moves in the same direction as the host vehicle,
deriving a sprayed distance of a sprayed object caused by the preceding vehicle when the preceding vehicle is detected and the road surface condition is a predetermined condition, and
calculating a recommended inter-vehicle distance on the basis of the spray distance.

2. The vehicle control device according to claim 1,
wherein the processor detects a type of a sprayed object present on the road surface on which the host vehicle travels as one of the road surface conditions, and derives a spray distance according to the type of the sprayed object.

3. The vehicle control device according to claim 1,
wherein the processor detects a type of the preceding vehicle and derives a spray distance based on the type of the preceding vehicle.

4. The vehicle control device according to claim 1,
wherein the processor detects a speed of the preceding vehicle and derives a spray distance according to the speed of the preceding vehicle.

5. The vehicle control device according to claim 1,
wherein the processor acquires a weather condition of the road surface on which the host vehicle is present, calculates a correction value based on the weather condition, and calculates the recommended inter-vehicle distance on the basis of the spray distance and the correction value.

6. The vehicle control device according to claim 1,
wherein the processor causes a display unit to display an image representing the preceding vehicle and the recommended inter-vehicle distance.

7. The vehicle control device according to claim 1,
wherein the processor causes a display unit to display an image in which a guide line is displayed at a position spaced the recommended inter-vehicle distance from a rear end of the preceding vehicle.

8. A vehicle control device comprising:
a storage device configured to store a program; and
a processor that is connected to the storage device,
wherein the processor executes a program stored in the storage device, thereby
detecting a road surface condition of a road surface on which a host vehicle is present,
detecting a preceding vehicle that is present in front of the host vehicle and moves in the same direction as the host vehicle,
deriving a spray distance of a sprayed object caused by the preceding vehicle when the preceding vehicle is detected and the road surface condition is a predetermined condition,
calculating a recommended inter-vehicle distance on the basis of the spray distance, and
controlling a drive device of the host vehicle so that an inter-vehicle distance with the preceding vehicle becomes the recommended inter-vehicle distance.

9. The vehicle control device according to claim 8,
wherein the processor ascertains a surrounding condition of the host vehicle, determines based on the surrounding condition whether a lane change to an adjacent lane of the host vehicle is possible, controls steering of the host vehicle, receives a setting of a target inter-vehicle distance between the host vehicle and the preceding vehicle by an occupant of the host vehicle, and
causes the host vehicle to change lanes when the target inter-vehicle distance is shorter than the recommended inter-vehicle distance and the lane change determination unit determines that a lane change is possible.

10. The vehicle control device according to claim 9,
wherein the processor causes the host vehicle to change lanes when the recommended inter-vehicle distance is greater than a predetermined distance and the lane change determination unit determines that a lane change is possible.

11. A vehicle control method executed using a computer, comprising:
detecting a road surface condition of a road surface on which a host vehicle is present;
detecting a preceding vehicle that is present in front of the host vehicle and moves in the same direction as the host vehicle;
deriving a spray distance of a sprayed object caused by the preceding vehicle when the preceding vehicle is detected and the road surface condition is a predetermined condition; and
calculating a recommended inter-vehicle distance on the basis of the spray distance.
